(19) United States
(12) Patent Application Publication
(10) Pub. No.: US 2012/0175194 A1
(43) Pub. Date: Jul. 12, 2012

(54) ELEVATOR TENSIONING SHEAVE APPARATUS

(75) Inventor: Takeshi Nikawa, Tokyo (JP)

(73) Assignee: MITSUBHISHI ELECTRIC CORPORATION, Tokyo (JP)

(21) Appl. No.: 13/496,319

(22) PCT Filed: Oct. 8, 2009
(86) PCT No.: PCT/JP2009/067545

§ 371 Date: Mar. 15, 2012

(51) Int. Cl. B66B 7/10; B66B 5/04

(52) U.S. Cl. 187/376; 187/373

(57) ABSTRACT

A tensioning sheave apparatus main body has a tensioning sheave around which the speed governor rope is wound. The tensioning sheave apparatus main body is suspended on the speed governor rope to apply tension. Vertical displacement of the tensioning sheave apparatus main body is guided by a tensioning sheave rail. A braking force generating apparatus suppresses upward displacement of the tensioning sheave apparatus main body by a braking force that is generated by gripping the tensioning sheave rail. The braking force generating apparatus allows the upward displacement of the tensioning sheave apparatus main body when the magnitude of an upward force that acts on the tensioning sheave apparatus main body is greater than or equal to a fixed value.

### TECHNICAL FIELD

The present invention relates to an elevator tensioning sheave apparatus that applies tension to a speed governor rope.

### BACKGROUND ART

In order to apply tension to a speed governor rope that is wound around a speed governor sheave and a tensioning sheave, elevator speed governing apparatuses are conventionally known that force the tensioning sheave away from the speed governor sheave by suspending a weight, etc., on the tensioning sheave, for example. In conventional elevator speed governing apparatuses, constructions have been proposed in which displacement of the tensioning sheave in a direction in which the speed governor rope stretches is allowed, and displacement of the tensioning sheave in a direction in which the speed governor rope contracts is prevented (See Patent Literature 1).

Elevator tensioning sheave apparatuses have been proposed conventionally in which a locking apparatus that forces a tensioning sheave away from a speed governor sheave while reeling in a wire rope that is connected to the tensioning sheave is installed on a pit floor. The locking apparatus is configured so as to lock the paying out of the wire rope if a sudden force acts in a direction in which the wire rope is paid out (see Patent Literature 2).

In addition, elevator tensioning sheave apparatuses have also been proposed conventionally in which a piston that is coupled to a tensioning sheave is disposed so as to be able to move vertically inside a cylinder that is filled with fluid, and an orifice is disposed on the piston so as to damp the vertical movement of the piston (see Patent Literature 2).

### CITATION LIST

### Patent Literature

[Patent Literature 1]

Japanese Patent Laid-Open No. SHO 47-42763 (Gazette)
[Patent Literature 2]

Japanese Patent Laid-Open No. HEI 6-211465 (Gazette)

### SUMMARY OF THE INVENTION

### Problem to be Solved by the Invention

However, in the elevator speed governing apparatus that is disclosed in Patent Literature 1, there is a risk that the speed governor rope or the speed governing apparatus may be damaged if the speed governor rope contracts due to changes in temperature, or humidity, for example, because the tension of the speed governor rope is significantly increased by stopping displacement of the tensioning sheave.

In the elevator tensioning sheave apparatus that is disclosed in Patent Literature 2, displacement of the tensioning sheave is stopped if the acceleration rate of the tensioning sheave is great, but if the tensioning sheave is displaced slowly by the contraction of the speed governor rope, it is impossible to apply appropriate braking force to the tensioning sheave for suppressing the displacement of the tensioning sheave.

The present invention aims to solve the above problems and an object of the present invention is to provide an elevator tensioning sheave apparatus that can more reliably maintain a state in which tension of a speed governor rope is appropriate not only when the speed governor rope stretches but also when the speed governor rope contracts.

### Means for Solving the Problem

In order to achieve the above object, according to one aspect of the present invention, there is provided an elevator tensioning sheave apparatus characterized in including: a tensioning sheave apparatus main body that has a tensioning sheave around which a speed governor rope is wound, and that is suspended on the speed governor rope to apply tension to the speed governor rope; a tensioning sheave rail that guides vertical displacement of the tensioning sheave apparatus main body; and a braking force generating apparatus that suppresses upward displacement of the tensioning sheave apparatus main body by a braking force that is generated by gripping the tensioning sheave rail, and that allows upward displacement of the tensioning sheave apparatus main body when a magnitude of an upward force that acts on the tensioning sheave apparatus main body is greater than or equal to a fixed value.

### Effects of the Invention

In an elevator tensioning sheave apparatus according to the present invention, because the upward displacement of the tensioning sheave apparatus main body is suppressed by the braking force that is generated by gripping the tensioning sheave rail, and the upward displacement of the tensioning sheave apparatus main body is allowed when the magnitude of the upward force that acts on the tensioning sheave apparatus main body is greater than or equal to the fixed value, an abnormally large braking force can be prevented from being applied to the tensioning sheave apparatus main body when the tensioning sheave apparatus main body is displaced upward. Consequently, a state in which the tension of the speed governor rope is appropriate can be more reliably maintained not only when the speed governor rope is stretched but also when the speed governor rope contracts.

### BRIEF DESCRIPTION OF THE DRAWINGS

FIG. 1 is a configuration diagram that shows an elevator according to Embodiment 1 of the present invention;

FIG. 2 is an enlargement that shows a tensioning sheave apparatus from FIG. 1;

FIG. 3 is a longitudinal cross section that shows a braking force generating apparatus from FIG. 2;

FIG. 4 is a longitudinal section that shows a state when the braking force generating apparatus from FIG. 3 generates a braking force on a tensioning sheave apparatus main body;

FIG. 5 is a longitudinal cross section that shows a braking force generating apparatus of an elevator tensioning sheave apparatus according to Embodiment 2 of the present invention;

FIG. 6 is a longitudinal cross section that shows a braking force generating apparatus of an elevator tensioning sheave apparatus according to Embodiment 3 of the present invention;

FIG. 7 is a front elevation that shows an elevator tensioning sheave apparatus according to Embodiment 4 of the present invention;

FIG. 8 is a longitudinal cross section that shows a braking force generating apparatus of an elevator tensioning sheave apparatus according to Embodiment 5 of the present invention;

FIG. 9 is a longitudinal section that shows a state when the braking force generating apparatus from FIG. 8 generates a braking force on a tensioning sheave apparatus main body;

FIG. 10 is a longitudinal cross section that shows a braking force generating apparatus of an elevator tensioning sheave apparatus according to Embodiment 6 of the present invention; and

FIG. 11 is a longitudinal cross section that shows a braking force generating apparatus of an elevator tensioning sheave apparatus according to Embodiment 7 of the present invention.

### DESCRIPTION OF EMBODIMENTS

Preferred embodiments of the present invention will now be explained with reference to the drawings.

### Embodiment 1

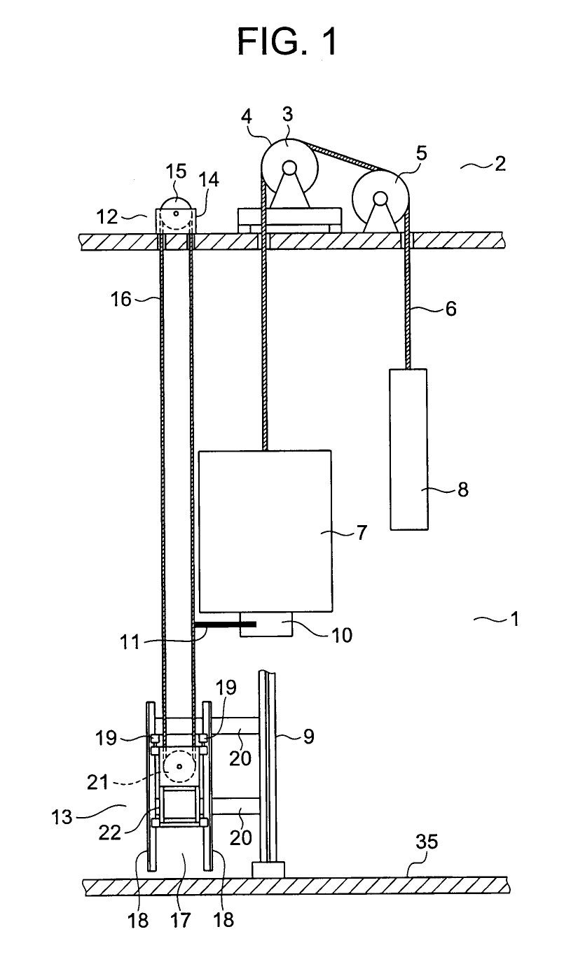

FIG. 1 is a configuration diagram that shows an elevator according to Embodiment 1 of the present invention. In the figure, a machine room 2 is disposed in an upper portion of a hoistway 1. Disposed inside the machine room 2 are: a hoisting machine (a driving machine) 4 that has a driving sheave 3; and a deflecting sheave 5 that is disposed so as to be positioned at a distance from the driving sheave 3.

A main rope 6 is wound around the driving sheave 3 and the deflecting sheave 5. A car 7 and a counterweight 8 that are raised and lowered inside the hoistway 1 are suspended by the main rope 6. The car 7 and the counterweight 8 are raised and lowered inside the hoistway 1 by rotation of the driving sheave 3.

A pair of car guide rails 9 that guide the car 7, and a pair of counterweight guide rails (not shown) that guide the counterweight 8 are installed inside the hoistway 1. Respective lower end portions of the car guide rails 9 and the counterweight guide rails are fixed to a bottom portion (a pit floor surface) 35 of the hoistway 1.

An emergency stopper apparatus 10 that stops the car 7 from falling is disposed on a lower portion of the car 7. A lifting bar (an operating arm) 11 is disposed on the emergency stopper apparatus 10. The emergency stopper apparatus 10 grips the car guide rails 9 by operation of the lifting bar 11. Falling of the car 7 is stopped by gripping of the car guide rails 9 by the emergency stopper apparatus 10.

A speed governor 12 is disposed inside the machine room 2, and a tensioning sheave apparatus 13 is disposed in a lower portion inside the hoistway 1. The speed governor 12 has: a speed governor main body 14; and a speed governor sheave 15 that is disposed on the speed governor main body 14.

A speed governor rope 16 that is connected to the lifting bar 11 is strung in a loop shape around the speed governor 12 and the tensioning sheave apparatus 13. A first end portion and a second end portion of the speed governor rope 16 are connected to the lifting bar 11. The speed governor rope 16 is thereby moved cyclically together with the movement of the car 7.

The tensioning sheave apparatus 13 has: a vertically displaceable tensioning sheave apparatus main body 17; first and second tensioning sheave rails 18 that guide the vertical displacement of the tensioning sheave apparatus main body 17; and a pair of braking force generating apparatuses 19 that apply a braking force to the tensioning sheave apparatus main body 17.

The tensioning sheave rails 18 face each other so as to be separated by a predetermined distance horizontally. The tensioning sheave rails 18 are fixed to two supporting arms 20 that are fixed to one of the car guide rails 9.

The tensioning sheave apparatus main body 17 is disposed between the tensioning sheave rails 18. The tensioning sheave apparatus main body 17 has: a tensioning sheave 21; and a supporting body 22 on which the tensioning sheave 21 is disposed. The speed governor rope 16 is wound around the speed governor sheave 15 and the tensioning sheave 21. The tensioning sheave apparatus main body 17 is suspended on the speed governor rope 16. Tension is applied to the speed governor rope 16 by a gravitational force that acts on the tensioning sheave apparatus main body 17.

The speed governor sheave 15 and the tensioning sheave 21 are rotated in response to the cyclic motion of the speed governor rope 16. If the speed of the car 7 increases and the rotational speed of the speed governor sheave 15 reaches a preset emergency overspeed (an overspeed), the speed governor rope 16 is gripped by the speed governor main body 14, stopping the cyclic motion of the speed governor rope 16. When the cyclic motion of the speed governor rope 16 is stopped, the lifting bar 11 is operated and the gripping operation of the emergency stopper apparatus 10 is performed. A braking force is thereby applied to the car 7 to prevent falling of the car 7.

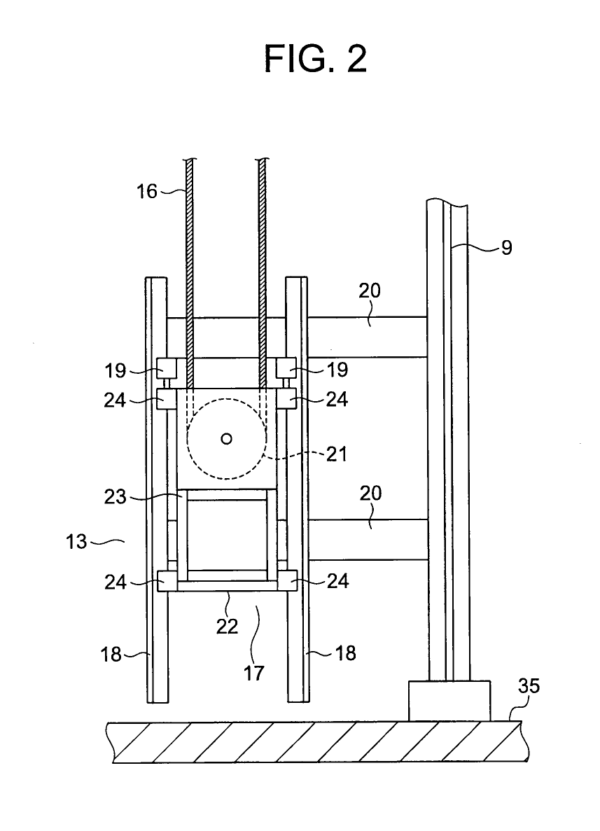

FIG. 2 is an enlargement that shows the tensioning sheave apparatus 13 from FIG. 1. In the figure, the supporting body 22 has: a supporting body main body 23 on which the tensioning sheave 21 is disposed; and a plurality of tensioning sheave guides 24 that are disposed on the supporting body main body 23, and that are guided by the tensioning sheave rails 18. In this example, pairs of tensioning sheave guides 24 that are guided separately by the first and second tensioning sheave rails 18 are respectively disposed at an upper end portion and a lower end portion of the supporting body main body 23.

Each of the braking force generating apparatuses 19 is disposed above the supporting body 22. Each of the braking force generating apparatuses 19 is supported separately by the pair of tensioning sheave guides 24 that are disposed on the upper end portion of the supporting body main body 23. Each of the braking force generating apparatuses 19 allows downward displacement of the tensioning sheave apparatus main body 17, and also generates a braking force on the tensioning sheave apparatus main body 17 on upward displacement of the tensioning sheave apparatus main body 17. The upward displacement of the tensioning sheave apparatus main body 17 is suppressed by the braking force that each of the braking force generating apparatuses 19 generates.

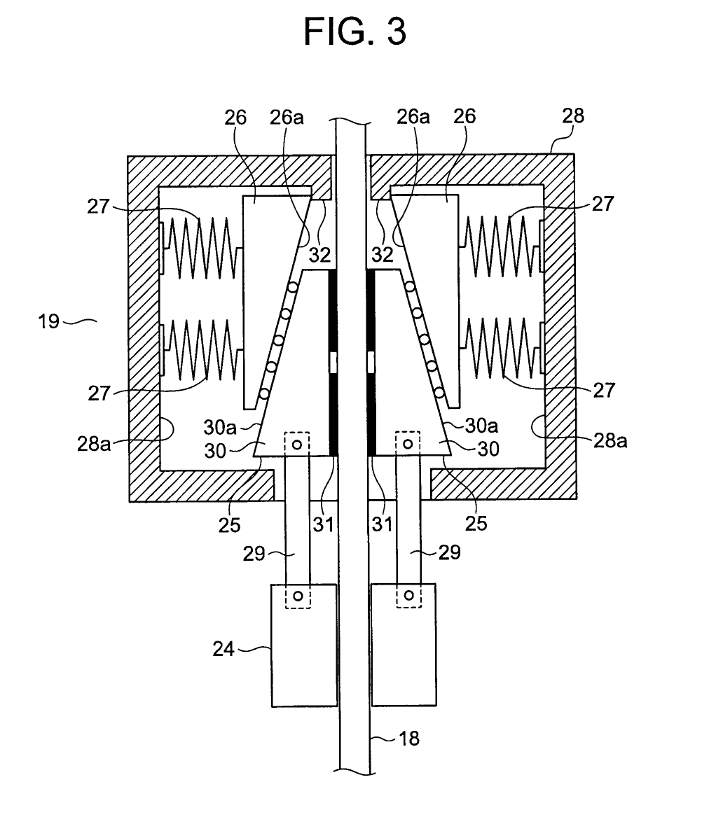

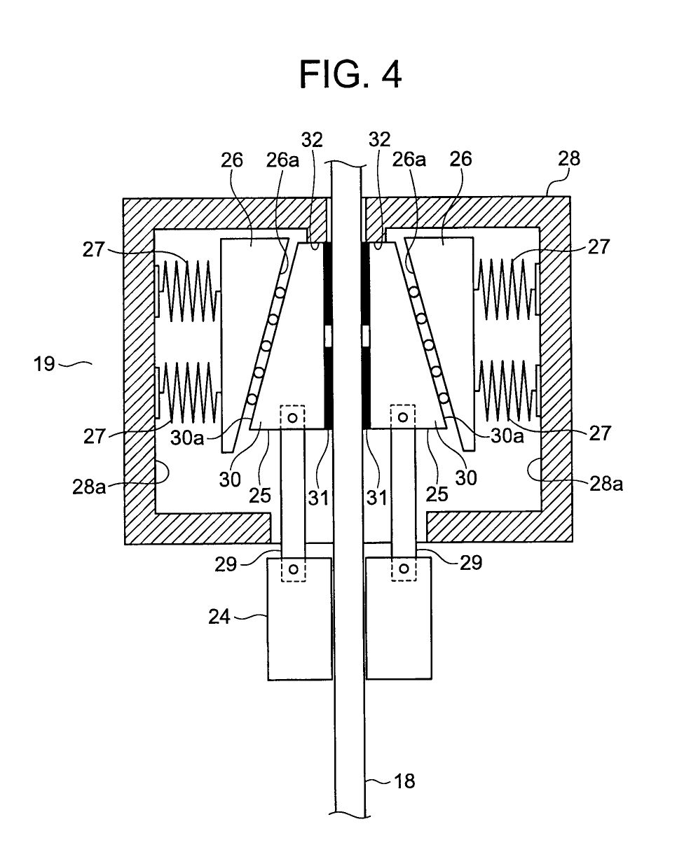

FIG. 3 is a longitudinal cross section that shows a braking force generating apparatus 19 from FIG. 2. FIG. 4 is a longitudinal section that shows a state when the braking force generating apparatus 19 from FIG. 3 generates a braking force on the tensioning sheave apparatus main body 17. In the figures, the braking force generating apparatus 19 has: a pair of braking bodies 25 that are positioned on opposite sides of a tensioning sheave rail 18 in contact with the tensioning sheave rail 18; a pair of guiding members 26 that hold the respective braking bodies 25 against the tensioning sheave rail 18 from opposite sides; a plurality of springs (forcing bodies) 27 that are elastic bodies that can generate forces that force the guiding members 26 in directions in which the braking bodies 25 grip the tensioning sheave rail 18; and a holder 28 that surrounds the braking bodies 25, the guiding members 26, and the springs 27. The braking force generating apparatus 19 generates a braking force on the tensioning sheave apparatus main body 17 by gripping the tensioning sheave rail 18 using the braking bodies 25.

Each of the braking bodies 25 is linked to a tensioning sheave guide 24 by means of a coupling rod 29. Each of the braking bodies 25 is thereby displaced vertically together with the tensioning sheave apparatus main body 17. Each of the braking bodies 25 has: a braking shoe 30 that is connected to the coupling rod 29; and a friction material 31 that is disposed on the braking shoe 30, and that contacts the tensioning sheave rail 18.

A braking body inclined surface 30a that is inclined relative to the tensioning sheave rail 18 is disposed on the braking shoe 30. Thus, a shape of the braking shoes 30 is a wedge shape in which dimensions in a horizontal direction are reduced continuously from a lower end portion toward an upper end portion.

A frictional force that corresponds to the gripping force of each of the braking bodies 25 on the tensioning sheave rail 18 is generated between the friction material 31 and the tensioning sheave rail 18. The frictional force that is generated between the friction material 31 and the tensioning sheave rail 18 is applied to the tensioning sheave apparatus main body 17 as the braking force.

A guiding member inclined surface 26a that is inclined relative to the tensioning sheave rail 18 in a direction that is parallel to the braking body inclined surface 30a is disposed on each of the guiding members 26. Thus, a shape of the guiding members 26 is a wedge shape in which dimensions in a horizontal direction are reduced continuously from an upper end portion toward a lower end portion.

The guiding members 26 are displaced toward the tensioning sheave rail 18 while being guided by the braking bodies 25 in response to upward displacement relative to the braking bodies 25, and are displaced away from the tensioning sheave rail 18 while being guided by the braking bodies 25 in response to downward displacement relative to the braking bodies 25. In other words, the guiding members 26 are displaced relative to the tensioning sheave rail 18 in a direction in which the distance from the tensioning sheave rail 18 changes in response to the vertical displacement relative to the braking bodies 25 while being guided by the braking bodies 25.

A pair of facing surfaces 28a that respectively face a back surface of each of the guiding members 26 are disposed on inner surfaces of the holder 28. Spacing between the guiding members 26 and the facing surfaces 28a is less than displacement of the guiding members 26 away from the tensioning sheave rail 18, and greater than displacement of the guiding members 26 toward the tensioning sheave rail 18.

A pair of stoppers 32 that separately restrict displacement of each of the guiding members 26 toward the tensioning sheave rail 18 are disposed on the holder 28. The displacement of the guiding members 26 toward the tensioning sheave rail 18 is restricted by the guiding members 26 contacting the stoppers 32. When the guiding members 26 contact the stoppers 32, predetermined gaps arise between the guiding members 26 and the tensioning sheave rail 18. The braking bodies 25 are inserted into the gaps between the guiding members 26 and the tensioning sheave rail 18.

First end portions of the springs 27 are connected to the guiding members 26, and second end portions of the springs 27 are connected to the facing surfaces 28a of the holder 28. The springs 27 are compressed between the guiding members 26 and the facing surfaces 28a. Thus, the springs 27 generate elastic repulsive forces in directions in which the guiding members 26 approach the tensioning sheave rail 18. The elastic repulsive forces of the springs 27 on the guiding members 26 are increased by displacement of the guiding members 26 away from the tensioning sheave rail 18.

Each of the braking bodies 25 bears a force in a direction in which the tensioning sheave rail 18 is gripped by the guiding members 26 being displaced away from the tensioning sheave rail 18 in opposition to the elastic repulsive force of each of the springs 27.

The guiding members 26, the springs 27 and the holder 28 are supported by the braking bodies 25 such that the guiding members 26 are mounted onto the braking bodies 25.

During normal operation, as shown in FIG. 3, the displacement of the guiding members 26 toward the tensioning sheave rail 18 is restricted by the stoppers 32. Consequently, only a force that corresponds to the total weight of the guiding members 26, the springs 27, and the holder 28 acts on the braking bodies 25. In this state, the guiding members 26 remain in contact with the stoppers 32 due to the elastic repulsive forces of the springs 27. Consequently, in this state, the braking bodies 25 are subjected to negligible force from the springs 27, and generate negligible braking force on the tensioning sheave apparatus main body 17.

If, for example, the speed governor rope 16 stretches due to aging, and the tensioning sheave apparatus main body 17 is displaced downward, because the tensioning sheave guides 24 is displaced in a direction that obeys gravitational force, the braking force generating apparatus 19 is displaced downward together with the tensioning sheave apparatus main body 17 due to the weight of the guiding members 26, the springs 27 and the holder 28 with the guiding members 26 remaining mounted on the braking bodies 25.

If the speed governor rope 16 contracts due to environmental changes such as temperature, humidity, for example, the tensioning sheave apparatus main body 17 is subjected to an upward force. If the tensioning sheave apparatus main body 17 is displaced upward, because the tensioning sheave guides 24 are displaced in an opposite direction to the direction of gravitational force, the braking bodies 25 are displaced upward relative to the guiding members 26, the springs 27, and the holder 28. Thus, the guiding members 26 are pressed by the braking bodies 25 while being displaced away from the tensioning sheave rail 18 in opposition to the elastic repulsive force of the springs 27. Thus, the restriction on displacement of the guiding members 26 toward the tensioning sheave rail 18 is disengaged, and the guiding members 26 are forced by the springs 27 in directions in which the braking bodies 25 are pressed onto the tensioning sheave rail 18 (in other words, in directions in which the braking bodies 25 grip the tensioning sheave rail 18). Thus, the braking force that is generated by the braking force generating apparatus 19 is increased.

As shown in FIG. 4, the upward displacement of the braking bodies 25 relative to the guiding members 26 is restricted by the braking bodies 25 contacting the stoppers 32 of the holder 28. Consequently, the displacement of the guiding members 26 away from the tensioning sheave rail 18 is also restricted in response to the restriction of the upward displacement of the braking bodies 25 relative to the holder 28. Thus, increases in the elastic repulsive force from the springs 27 are also stopped, and the magnitude of the gripping force of the braking bodies 25 on the tensioning sheave rail 18 reaches a maximum value by the braking bodies 25 contacting the stoppers 32. The maximum value of the gripping force of the braking bodies 25 is set to a predetermined set value by adjusting the strength, number, etc., of springs 27. In other words, the braking force generating apparatus 19 increases the gripping force on the tensioning sheave rail 18 in response to the upward displacement of the tensioning sheave apparatus main body 17, and when the magnitude of the increased gripping force reaches a predetermined set value, maintains the magnitude of the gripping force at the set value.

After the magnitude of the gripping force on the tensioning sheave rail 18 reaches the predetermined set value, the magnitude of the gripping force on the tensioning sheave rail 18 does not change even if the tensioning sheave apparatus main body 17 is displaced further upward, nor does the magnitude of the braking force from the braking force generating apparatus 19 change.

The upward force that acts on the tensioning sheave apparatus main body 17 increases in response to the upward displacement of the tensioning sheave apparatus main body 17. If the magnitude of the upward force that acts on the tensioning sheave apparatus main body 17 becomes greater than or equal to a total value (a fixed value) that is the sum of the magnitude of the braking force (maximum value of braking force) from the braking force generating apparatus 19 when the magnitude of the gripping force on the tensioning sheave rail 18 is being maintained at the predetermined set value and the magnitude of the gravitational force that acts on the tensioning sheave apparatus main body 17, the tensioning sheave apparatus main body 17 is displaced upward together with the entire braking force generating apparatus 19, allowing upward displacement of the tensioning sheave apparatus main body 17.

The braking force that is generated by the braking force generating apparatus 19 is less than the gravitational force that acts on the tensioning sheave apparatus main body 17. In other words, the magnitude of the braking force that is generated by the braking force generating apparatus 19 will never reach a value that is greater than or equal to the gravitational force that acts on the tensioning sheave apparatus main body 17 even if the magnitude of the gripping force from the braking bodies 25 is at the predetermined set value.

Next, operation will be explained. If the speed of the descending car 7 increases abnormally for any reason and the rotational speed of the speed governor sheave 15 reaches the overspeed, the speed governor rope 16 is gripped by the speed governor main body 14. Thus, movement of the speed governor rope 16 stops, and the car 7 is displaced relative to the speed governor rope 16.

When the car 7 is displaced relative to the speed governor rope 16, the lifting bar 11 is operated, and an operation that grips the car guide rails 9 is performed by the emergency stopper apparatus 10. A braking force is thereby applied to the car 7 to prevent falling of the car 7.

Next, operation of the braking force generating apparatus 19 will be explained. During normal operation, the guiding members 26 are mounted onto the braking bodies 25 such that the guiding members 26 contact the stoppers 32. Here, because the braking bodies 25 are subjected to negligible force from the springs 27, negligible braking force arises from the braking force generating apparatus 19 on the tensioning sheave apparatus main body 17.

If the speed governor rope 16 stretches due to aging, for example, because negligible braking force arises from the braking force generating apparatus 19, the tensioning sheave apparatus main body 17 is displaced downward together with the braking force generating apparatus 19 under its own weight. Thus, tension in the speed governor rope 16 is maintained appropriately.

On the other hand, if the speed governor rope 16 contracts due to environmental changes in temperature, or humidity, for example, the tensioning sheave apparatus main body 17 is subjected to an upward force, and is displaced upward together with the braking bodies 25. The spacing between the guiding members 26 and the tensioning sheave rail 18 is thereby pushed wider apart by the braking bodies 25. Here, the springs 27 are compressed, increasing the force from the springs 27. Thus, the gripping force from the braking bodies 25 on the tensioning sheave rail 18 is increased, increasing the braking force from the braking force generating apparatus 19 on the tensioning sheave apparatus main body 17. Consequently, the upward force that acts on the tensioning sheave apparatus main body 17 increases together with the upward displacement of the tensioning sheave apparatus main body 17.

If the speed governor rope 16 contracts further, displacing the braking bodies 25 upward as the upward force that acts on the tensioning sheave apparatus main body 17 increases, the braking bodies 25 contact the stoppers 32 of the holder 28. The magnitude of the gripping force from the braking bodies 25 thereby reaches the predetermined set value (FIG. 4). The magnitude of the braking force from the braking force generating apparatus 19 on the tensioning sheave apparatus main body 17 thereby reaches a maximum.

If the speed governor rope 16 subsequently contracts further, the entire braking force generating apparatus 19 is displaced upward together with the tensioning sheave apparatus main body 17 such that the braking bodies 25 remain in contact with the stoppers 32. Here, because the amount of compression in the springs 27 is maintained, the gripping force from the braking bodies 25 does not increase, maintaining the gripping force from the braking bodies 25 at the predetermined set value. Consequently, the tensioning sheave apparatus main body 17 is displaced upward together with the braking force generating apparatus 19 such that the braking force from the braking force generating apparatus 19 is maintained. Thus, the upward displacement of the tensioning sheave apparatus main body 17 is suppressed by the braking force from the braking force generating apparatus 19, and the upward force that the tensioning sheave apparatus main body 17 bears is also prevented from increasing abnormally.

In an elevator tensioning sheave apparatus of this kind, because the upward displacement of the tensioning sheave apparatus main body 17 is suppressed by the braking force that is generated by gripping of the tensioning sheave rail 18, and the upward displacement of the tensioning sheave apparatus main body 17 is allowed when the magnitude of the upward force that acts on the tensioning sheave apparatus main body 17 becomes greater than or equal to the fixed value, abnormally large braking forces can be prevented from acting on the tensioning sheave apparatus main body 17 when the tensioning sheave apparatus main body 17 is displaced upward. Consequently, a state in which the tension of the speed governor rope 16 is appropriate can be more reliably maintained not only when the speed governor rope 16 stretches but also when the speed governor rope 16 contracts.

Because the braking force generating apparatus 19 is configured so as to increase the gripping force on the tensioning sheave rail 18 in response to the upward displacement of the tensioning sheave apparatus main body 17, and to maintain the gripping force when the increasing gripping force reaches a predetermined value, upward displacement of the tensioning sheave apparatus main body 17 can be suppressed in response to the amount of displacement thereof by adjusting the gripping force on the tensioning sheave rail 18, and an abnormally large braking force can also be prevented from acting on the tensioning sheave apparatus main body 17 when the tensioning sheave apparatus main body 17 is displaced upward.

Because the braking force that is generated by the braking force generating apparatus 19 is less than the gravitational force that acts on the tensioning sheave apparatus main body 17, even if the speed governor rope 16 stretches when the braking force is being generated by the braking force generating apparatus 19, the tensioning sheave apparatus main body 17 can be prevented from being held by the braking force from the braking force generating apparatus 19, enabling the tensioning sheave apparatus main body 17 to be displaced downward more reliably.

Because the guiding members 26 are displaced away from the tensioning sheave rail 18 while being guided by the braking bodies 25 in response to the upward displacement of the tensioning sheave apparatus main body 17, and the forces from the springs 27 increase in response to the displacement of the guiding members 26 away from the tensioning sheave rail 18, the braking force on the tensioning sheave apparatus main body 17 can be more reliably generated. Adjustment of the braking force on the tensioning sheave apparatus main body 17 can also be performed easily by adjusting the strength, number, etc., of springs 27.

Because the guiding member inclined surfaces 26a, which are inclined relative to the tensioning sheave rail 18, are disposed on the guiding members 26, and the braking body inclined surfaces 30a, which are parallel to the guiding member inclined surfaces 26a, are disposed on the braking bodies 25, displacement of the guiding members 26 relative to the tensioning sheave rail 18 when the tensioning sheave apparatus main body 17 is displaced vertically can be achieved using a simple construction.

### Embodiment 2

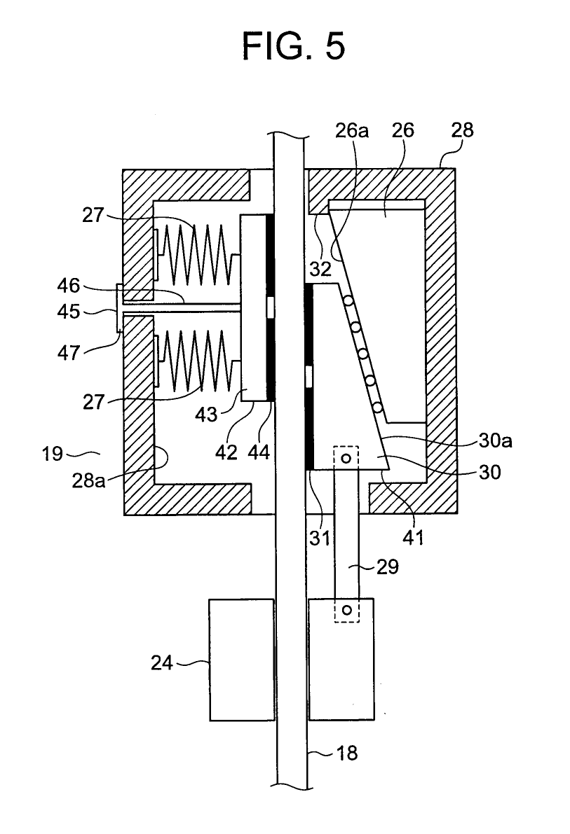

FIG. 5 is a longitudinal cross section that shows a braking force generating apparatus of an elevator tensioning sheave apparatus according to Embodiment 2 of the present invention. In the figure, of a pair of braking bodies 41 and 42, a first braking body 41 has a similar or identical construction to the braking bodies 25 according to Embodiment 1. A second braking body 42 has: a tabular braking shoe 43; and a friction material 44 that is disposed on the braking shoe 43, and that contacts the tensioning sheave rail 18. Of the braking bodies 41 and 42, only the first braking body 41 is linked to a tensioning sheave guide 24 by means of a coupling rod 29. A braking force generating apparatus 19 generates a braking force on a tensioning sheave apparatus main body 17 by gripping a tensioning sheave rail 18 using the braking bodies 41 and 42.

A guiding member 26 is mounted only onto the first braking body 41 and none is mounted onto the second braking body 42. The guiding member 26 is displaced relative to the first braking body 41 while a guiding member inclined surface 26a is guided along a braking body inclined surface 30a of the braking body 41. Consequently, the guiding member 26 is displaced toward the tensioning sheave rail 18 by upward displacement relative to the braking body 41, and is displaced away from the tensioning sheave rail 18 by downward displacement relative to the braking body 41. In other words, the guiding member 26 is displaced relative to the tensioning sheave rail 18 in a direction in which the distance from the tensioning sheave rail 18 changes in response to the vertical displacement relative to the braking body 41 while being guided by the first braking body 41.

The guiding member 26 is fixed to a holder 28. Consequently, the holder 28 is displaced relative to the tensioning sheave rail 18 together with the guiding member 26. A facing surface 28a that faces a back surface of the second braking body 42 is disposed on the holder 28. The facing surface 28a is displaced toward the braking body 42 by the guiding member 26 being displaced away from the tensioning sheave rail 18, and is displaced away from the braking body 42 by the guiding member 26 being displaced toward the tensioning sheave rail 18.

A stopper 45 that restricts the second braking body 42 from being displaced away from the facing surface 28a is disposed on the braking shoe 43. The stopper 45 has: a guiding rod 46 that passes slidably through the holder 28; and an engaging portion 47 that is disposed on a tip end portion of the guiding rod 46. The guiding rod 46 is disposed horizontally. Displacement of the second braking body 42 away from the facing surface 28a is restricted by an outer surface of the holder 28 contacting the engaging portion 47.

Springs 27 are compressed between the facing surface 28a and the second braking body 42. First end portions of the springs 27 are connected to the braking shoe 43, and the second end portions of the springs 27 are connected to the facing surface 28a. The springs 27 generate an elastic repulsive force in a direction in which the facing surface 28a and the braking body 42 move away from each other. Thus, the springs 27 force the guiding member 26 and the second braking body 42 in directions in which the braking bodies 41 and 42 grip the tensioning sheave rail 18. The rest of the configuration is similar or identical to that of Embodiment 1.

Next, operation of the braking force generating apparatus 19 will be explained. During normal operation, the guiding member 26 is mounted onto the first braking body 41 such that displacement of the second braking body 42 relative to the facing surface 28a is restricted by the stopper 45, and the braking bodies 41 and 42 contact the tensioning sheave rail 18. Here, because negligible gripping force is generated by the braking bodies 41 and 42, braking force from the braking force generating apparatus 19 on the tensioning sheave apparatus main body 17 is reduced.

If the speed governor rope 16 stretches, the tensioning sheave apparatus main body 17 is displaced downward under its own weight in opposition to the braking force from the braking force generating apparatus 19. Thus, tension in the speed governor rope 16 is maintained appropriately.

On the other hand, if the speed governor rope 16 contracts and the tensioning sheave apparatus main body 17 is displaced upward together with the first braking body 41, spacing between the guiding member 26 and the tensioning sheave rail 18 is pushed wider apart by the first braking body 41. The springs 27 are thereby compressed, increasing the force from the springs 27. Thus, the gripping force from the braking bodies 41 and 42 on the tensioning sheave rail 18 is increased, increasing the braking force from the braking force generating apparatus 19 on the tensioning sheave apparatus main body 17.

If the speed governor rope 16 contracts further, and the first braking body 41 contacts the stopper 32 of the holder 28, the magnitude of the gripping force from the braking bodies 41 and 42 thereby reaches a predetermined value. The braking force that is generated by the braking force generating apparatus 19 thereby reaches a maximum.

If the speed governor rope 16 subsequently contracts further, the tensioning sheave apparatus main body 17 is displaced upward together with the braking force generating apparatus 19 such that the braking force from the braking force generating apparatus 19 is maintained.

In an elevator tensioning sheave apparatus of this kind, because the guiding member 26 is displaced away from the tensioning sheave rail 18 while being guided by the first braking body 41 in response to the upward displacement of the tensioning sheave apparatus main body 17, and the force from the springs 27 increases in response to the displacement of the guiding member 26 away from the tensioning sheave rail 18, upward displacement of the tensioning sheave apparatus main body 17 can also be suppressed by adjusting the force from the springs 27. Abnormally large braking forces can be prevented from acting on the tensioning sheave apparatus main body 17 when the tensioning sheave apparatus main body 17 is displaced upward. Consequently, a state in which the tension of the speed governor rope 16 is appropriate can be more reliably maintained not only when the speed governor rope 16 stretches but also when the speed governor rope 16 contracts.

### Embodiment 3

Moreover, in Embodiment 2, the guiding member 26 is fixed to the holder 28, and the springs 27 are compressed between the second braking body 42 and the holder 28, but the second braking body 42 may also be fixed to the holder 28, and springs 27 disposed under compression between the guiding member 26 and the holder 28.

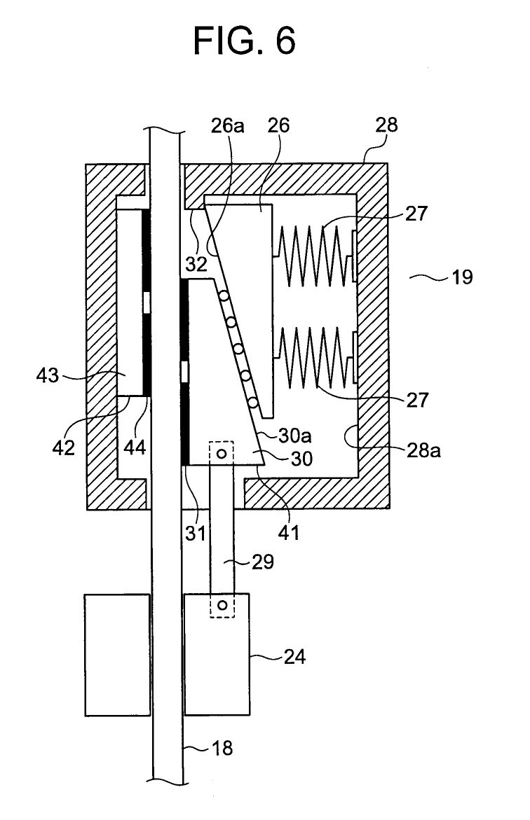

FIG. 6 is a longitudinal cross section that shows a braking force generating apparatus of an elevator tensioning sheave apparatus according to Embodiment 3 of the present invention. In the figure, a guiding member 26 is displaceable relative to a holder 28. A facing surface 28a that faces a back surface of the guiding member 26 is disposed on the holder 28. A stopper 32 that restricts displacement of the guiding member 26 toward a tensioning sheave rail 18 is also disposed on the holder 28. Springs 27 are compressed between the guiding member 26 and the facing surface 28a. First end portions of the springs 27 are connected to the guiding member 26, and second end portions of the springs 27 are connected to the facing surface 28a. A second braking body 42 is fixed to the holder 28. The rest of the configuration is similar or identical to that of Embodiment 2.

In an elevator tensioning sheave apparatus of this kind, a state in which the tension of the speed governor rope 16 is appropriate can also be more reliably maintained not only when the speed governor rope 16 stretches but also when the speed governor rope 16 contracts.

### Embodiment 4

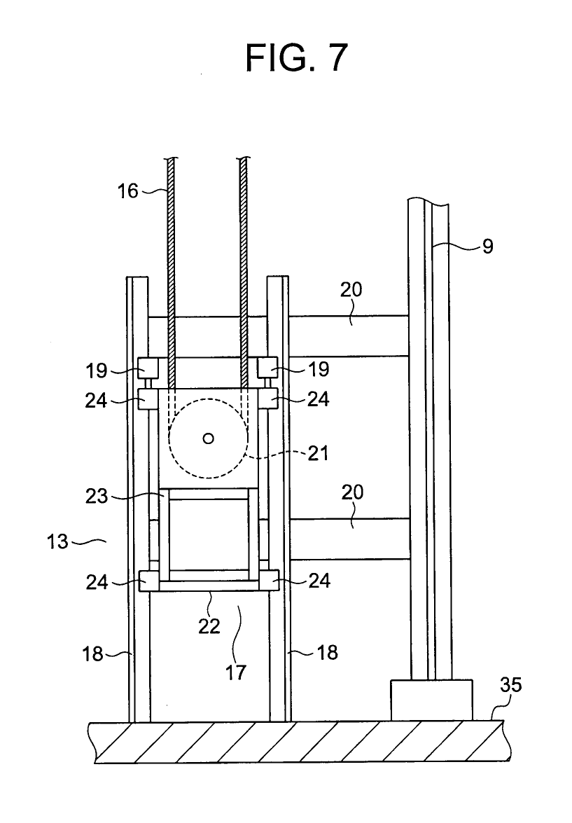

FIG. 7 is a front elevation that shows an elevator tensioning sheave apparatus according to Embodiment 4 of the present invention. In the figure, tensioning sheave rails 18 are fixed to a bottom portion (a pit floor surface) 35 of a hoistway 1. Examples of methods for fixing the tensioning sheave rails 18 to the pit floor surface 35 include: fixing by anchor bolts; or fixing by embedding lower end portions of the tensioning sheave rails 18 in the pit floor surface 35, for example. The rest of the configuration is similar or identical to that of Embodiment 1.

In an elevator tensioning sheave apparatus of this kind, because the tensioning sheave rails 18 are fixed to the pit floor surface 35 of the hoistway 1, the upward force that acts on the tensioning sheave rails 18 can be supported by the pit floor surface 35 of the hoistway 1. Consequently, even if the tensioning sheave rails 18 are mounted to the car guide rails 2 by means of the supporting arms 20, the moment load that acts on the supporting arms 20 can be reduced, enabling the strength that is required in the supporting arms 20 to be reduced. Cost reductions for the supporting arms 20 are thereby enabled.

### Embodiment 5

In Embodiment 1, the configuration is such that the braking bodies 25 are respectively linked to the tensioning sheave guides 24 by means of coupling rods 29, and the guiding members 26, the springs 27, and the holder 28 are supported by the braking bodies 25, but a configuration may also be adopted in which a holder 28 is fixed to a tensioning sheave guide 24, and braking bodies 25 are supported by guiding members 26.

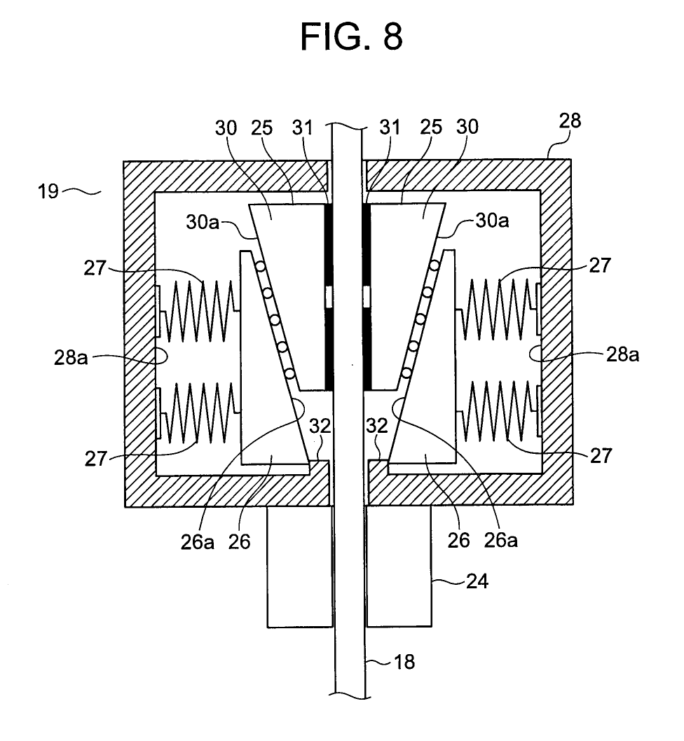

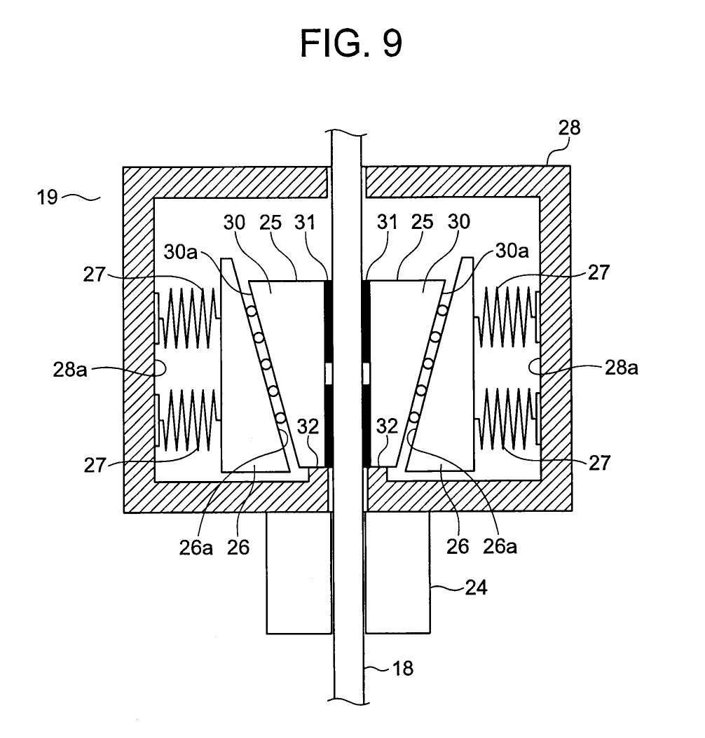

FIG. 8 is a longitudinal cross section that shows a braking force generating apparatus of an elevator tensioning sheave apparatus according to Embodiment 5 of the present invention. FIG. 9 is a longitudinal section that shows a state when the braking force generating apparatus from FIG. 8 generates a braking force on a tensioning sheave apparatus main body 17. In the figures, a holder 28 is fixed to a tensioning sheave guide 24. Consequently, the holder 28 is displaced together with the tensioning sheave apparatus main body 17. Braking bodies 25 are mounted onto guiding members 26 so as to be inserted between the guiding members 26 and a tensioning sheave rail 18.

Braking body inclined surfaces 30a that are inclined relative to the tensioning sheave rail 18 are disposed on braking shoes 30 of the braking bodies 25. Dimensions of the braking shoes 30 in a horizontal direction are reduced continuously from an upper end portion toward a lower end portion.

Guiding member inclined surfaces 26a that are inclined relative to the tensioning sheave rail 18 in directions that are parallel to the braking body inclined surfaces 30a are disposed on the guiding members 26. Thus, dimensions of the guiding members 26 in a horizontal direction are reduced continuously from a lower end portion toward an upper end portion.

The guiding members 26 are displaced away from the tensioning sheave rail 18 while being guided by the braking bodies 25 in response to upward displacement of the tensioning sheave apparatus main body 17, and displaced toward the tensioning sheave rail 18 while being guided by the braking bodies 25 in response to downward displacement of the tensioning sheave apparatus main body 17.

The displacement of each of the guiding members 26 toward the tensioning sheave rail 18 is separately restricted by a pair of stoppers 32 that are disposed on the holder 28. Displacement of the guiding members 26 away from the tensioning sheave rails 18 is restricted by the braking bodies 25 contacting the stoppers 32 on the holder 28. The rest of the configuration is similar or identical to that of Embodiment 1.

Next, operation of the braking force generating apparatus 19 will be explained. During normal operation, as shown in FIG. 8, because the displacement of the guiding members 26 toward the tensioning sheave rail 18 is restricted by the stoppers 32, negligible gripping force is generated by the braking bodies 25.

If the speed governor rope 16 stretches, the tensioning sheave apparatus main body 17 is displaced downward under its own weight together with the guiding members 26, the springs 27, and the holder 28. Here, the braking bodies 25 are also displaced downward under their own weight together with the downward displacement of the guiding members 26. Thus, tension in the speed governor rope 16 is maintained appropriately.

On the other hand, if the speed governor rope 16 contracts and the tensioning sheave apparatus main body 17 is displaced upward together with the guiding members 26, the springs 27, and the holder 28, spacing between the guiding members 26 and the tensioning sheave rail 18 is pushed wider apart by the braking bodies 25. The springs 27 are thereby compressed, increasing the force from the springs 27. Thus, the gripping force from the braking bodies 25 on the tensioning sheave rail 18 is increased, increasing the braking force from the braking force generating apparatus 19 on the tensioning sheave apparatus main body 17.

If the speed governor rope 16 contracts further, and the stoppers 32 on the holder 28, which are displaced upward, contact the braking bodies 25, as shown in FIG. 9, the magnitude of the gripping force from the braking bodies 25 reaches a predetermined value. The braking force that is generated by the braking force generating apparatus 19 thereby reaches a maximum.

If the speed governor rope 16 subsequently contracts further, the entire braking force generating apparatus 19 is displaced upward together with the tensioning sheave apparatus main body 17 in a state in which the stoppers 32 are in contact with the braking bodies 25 (i.e., the braking force from the braking force generating apparatus 19 is maintained).

In an elevator tensioning sheave apparatus of this kind, the upward displacement of the tensioning sheave apparatus main body 17 can also be suppressed by adjusting the force from of the springs 27. Abnormally large braking forces can be prevented from acting on the tensioning sheave apparatus main body 17 when the tensioning sheave apparatus main body 17 is displaced upward. Consequently, a state in which the tension of the speed governor rope 16 is appropriate can be more reliably maintained not only when the speed governor rope 16 stretches but also when the speed governor rope 16 contracts.

### Embodiment 6

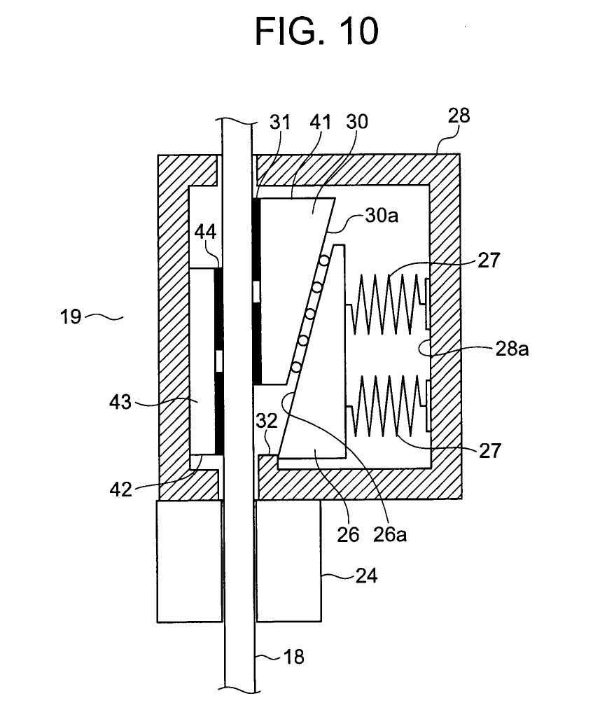

FIG. 10 is a longitudinal cross section that shows a braking force generating apparatus of an elevator tensioning sheave apparatus according to Embodiment 6 the present invention. In the figure, of a pair of braking bodies 41 and 42, a first braking body 41 has a similar or identical construction to the braking bodies 25 according to Embodiment 5. A guiding member 26 also has a similar or identical construction to the guiding members 26 according to Embodiment 5. guiding member 26 is fixed to a holder 28. The holder 28 is fixed to a tensioning sheave guide 24. The rest of the configuration is similar or identical to that of Embodiment 2.

an elevator tensioning sheave apparatus of this kind, a state in which the tension of the speed governor rope 16 is appropriate can also be more reliably maintained not only when the speed governor rope 16 stretches but also when the speed governor rope 16 contracts.

### Embodiment 7

Moreover, in Embodiment 6, the guiding member 26 is fixed to the holder 28, and the springs 27 are compressed between the second braking body 42 and the holder 28, but the second braking body 42 may also be fixed to the holder 28, and springs 27 disposed under compression between the guiding member 26 and the holder 28.

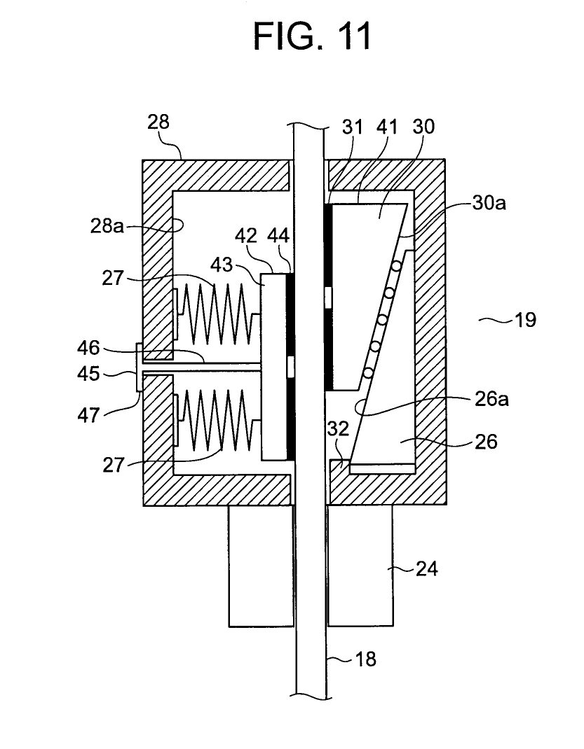

FIG. 11 is a longitudinal cross section that shows a braking force generating apparatus of an elevator tensioning sheave apparatus according to Embodiment 7 of the present invention. In the figure, a guiding member 26 is displaceable relative to a holder 28. A facing surface 28a that faces a back surface of the guiding member 26 is disposed on the holder 28. A stopper 32 that restricts displacement of the guiding member 26 toward a tensioning sheave rail 18 is also disposed on the holder 28. Springs 27 are compressed between the guiding member 26 and the facing surface 28a. First end portions of the springs 27 are connected to the guiding member 26, and second end portions of the springs 27 are connected to the facing surface 28a. A second braking body 42 is fixed to the holder 28. The rest of the configuration is similar or identical to that of Embodiment 6.

In an elevator tensioning sheave apparatus of this kind, a state in which the tension of the speed governor rope 16 is appropriate can also be more reliably maintained not only when the speed governor rope 16 stretches but also when the speed governor rope 16 contracts.

Moreover, in each of the above embodiments, the gripping force from the braking bodies increases in response to the upward displacement of the tensioning sheave apparatus main body 17 until the magnitude of the gripping force of the braking bodies reaches a predetermined set value, but a braking force generating apparatus may also be disposed on the tensioning sheave rails 18 such that the magnitude of the gripping force from the braking bodies is maintained at a predetermined set value by forces from springs. In that case, the braking force generating apparatus has: a pair of braking bodies; and springs (forcing bodies) that force the braking bodies in directions in which the tensioning sheave rails 18 are gripped. The braking force generating apparatus is held independently from the tensioning sheave apparatus main body 17 as a stopper on the tensioning sheave rails 18 by the braking bodies gripping the tensioning sheave rails 18. The tensioning sheave apparatus main body 17 contacts the braking force generating apparatus by upward displacement, and the tensioning sheave apparatus main body 17 is displaced upward together with the braking force generating apparatus when the upward force that acts on the tensioning sheave apparatus main body 17 becomes greater than or equal to a fixed value.

### EXPLANATION OF NUMBERING

13 TENSIONING SHEAVE APPARATUS, 16 SPEED GOVERNOR ROPE, 17 TENSIONING SHEAVE APPARATUS MAIN BODY, 18 TENSIONING SHEAVE RAIL, 19 BRAKING FORCE GENERATING APPARATUS, 25, 41, AND 42 BRAKING BODY, 26 GUIDING MEMBER, 26A GUIDING MEMBER INCLINED SURFACE, 27 SPRING (FORCING BODY), 30A BRAKING BODY INCLINED SURFACE, 35 PIT FLOOR SURFACE.

1. An elevator tensioning sheave apparatus comprising:
a tensioning sheave apparatus main body that has a tensioning sheave around which a speed governor rope is wound, and that is suspended on the speed governor rope to apply tension to the speed governor rope;
a tensioning sheave rail that guides vertical displacement of the tensioning sheave apparatus main body; and
a braking force generating apparatus that suppresses upward displacement of the tensioning sheave apparatus main body by a braking force that is generated by gripping the tensioning sheave rail, and that allows upward displacement of the tensioning sheave apparatus main body when a magnitude of an upward force that acts on the tensioning sheave apparatus main body is greater than or equal to a fixed value.

2. An elevator tensioning sheave apparatus according to claim 1, wherein the braking force generating apparatus increases a gripping force on the tensioning sheave rail in response to the upward displacement of the tensioning sheave apparatus main body, and maintains the gripping force at a predetermined set value when the increasing gripping force reaches the set value.

3. An elevator tensioning sheave apparatus according to claim 1, wherein the braking force that is generated by the braking force generating apparatus is less than a gravitational force that acts on the tensioning sheave apparatus main body.

4. An elevator tensioning sheave apparatus according to claim 1, wherein the tensioning sheave rail is fixed to a pit floor surface of a hoistway.

5. An elevator tensioning sheave apparatus according to claim 2, wherein the braking force generating apparatus comprises:
a pair of braking bodies that are positioned on opposite sides of the tensioning sheave rail in contact with the tensioning sheave rail;
a pair of guiding members that are respectively positioned on opposite sides of the braking bodies from the tensioning sheave rail, and that are displaced away from the tensioning sheave rail while being guided by each of the braking bodies in response to the upward displacement of the tensioning sheave apparatus main body; and
a forcing body that can generate a force that forces each of the guiding members in a direction in which each of the braking bodies grips the tensioning sheave rail, and that increases the force in response to displacement of the guiding member away from the tensioning sheave rail.

6. An elevator tensioning sheave apparatus according to claim 2, wherein the braking force generating apparatus comprises:
first and second braking bodies that are positioned on opposite sides of the tensioning sheave rail in contact with the tensioning sheave rail;
a guiding member that is positioned on an opposite side of the first braking body from the tensioning sheave rail, and that is displaced away from the tensioning sheave rail while being guided by the first braking body in response to the upward displacement of the tensioning sheave apparatus main body; and
a forcing body that can generate a force that forces the guiding member and the second braking body in directions in which each of the braking bodies grips the tensioning sheave rail, and that increases the force in response to displacement of the guiding member away from the tensioning sheave rail.

7. An elevator tensioning sheave apparatus according to claim 5, wherein:
a guiding member inclined surface that is inclined relative to the tensioning sheave rail is disposed on the guiding member; and
a braking body inclined surface that is parallel to the guiding member inclined surface is disposed on the braking body that guides the guiding member.

8. An elevator tensioning sheave apparatus according to claim 6, wherein:
a guiding member inclined surface that is inclined relative to the tensioning sheave rail is disposed on the guiding member; and
a braking body inclined surface that is parallel to the guiding member inclined surface is disposed on the braking body that guides the guiding member.
